(19) United States
(12) Patent Application Publication
(10) Pub. No.: US 2011/0315025 A1
(43) Pub. Date: Dec. 29, 2011

(54) SHEAR DEFLECTION ANGLE DETECTION

(75) Inventor: Kevin Barry Wright, Senoia, GA (US)

(73) Assignee: Harris Waste Management Group, Inc., Tyrone, GA (US)

(21) Appl. No.: 12/822,726

(22) Filed: Jun. 24, 2010

(51) Int. Cl. B30B 15/00

(52) U.S. Cl. 100/35; 100/99

(57) ABSTRACT

A recycling machine deflection detection system including a cross head movable within a shear box of a recycling machine, one or more sensor units disposed on the cross head, and a controller connected to the one or more sensor units, the controller being configured to receive deflection signals from the one or more sensor units and determine, from the deflection signals, a shear deflection angle of the cross head due to deformation of the cross head.

### BACKGROUND

1. Field

The exemplary embodiments generally relate to recycling equipment and, more particularly, to detecting deflection of a shear of the recycling equipment.

2. Brief Description of Related Developments

In, for example, recycling equipment such as shears and bailers, a pair of knives (or shears) is used to sever scrap material into smaller pieces for recycling. Generally, one of the shears is movable while the other is stationary. When, for example, the shears are not maintained with respect to sharpness or gap between the shears excessive forces are generated that cause at least the movable shear to separate away from the stationary shear in a direction normal to the shear plane. The increased space between the movable and stationary shear may allow the scrap material to bind between the shears causing the recycling equipment to jam or otherwise become damaged. The jamming or damaging of the recycling equipment may cause extensive machine down time and repair costs as well as create hazards related to the repair operation. In anticipation of a jamming event during the use of the recycling equipment, shears are generally manufactured with additional material to increase the strength and durability of the shears. This increased robustness of the shears also increases the cost of designing and manufacturing the shears.

It would be advantageous to be able to measure a deflection of shears so as to halt the shearing process prior to jamming of the recycling equipment.

### BRIEF DESCRIPTION OF THE DRAWINGS

The foregoing aspects and other features of the disclosed embodiments are explained in the following description, taken in connection with the accompanying drawings, wherein:

FIGS. 1A-1C are exemplary illustrations of portions of an exemplary recycling machine in accordance with an exemplary embodiment;

FIGS. 2A-2C, are schematic illustrations of the recycling machine of FIGS. 1A-1C;

FIGS. 3A-3C are schematic illustration of a portion of the recycling machine of FIGS. 1A-1C;

FIG. 4 is a schematic illustration of a shear deflection angle detection system in accordance with an exemplary embodiment;

FIG. 5 is another schematic illustration of the shear deflection angle detection of FIG. 4 in accordance with an exemplary embodiment;

FIG. 6 is a schematic illustration of shear deflection angle detection system in accordance with an exemplary embodiment; and

FIG. 7 is another schematic illustration of the shear deflection angle detection of FIG. 6 in accordance with an exemplary embodiment.

### DETAILED DESCRIPTION OF THE EXEMPLARY EMBODIMENT(S)

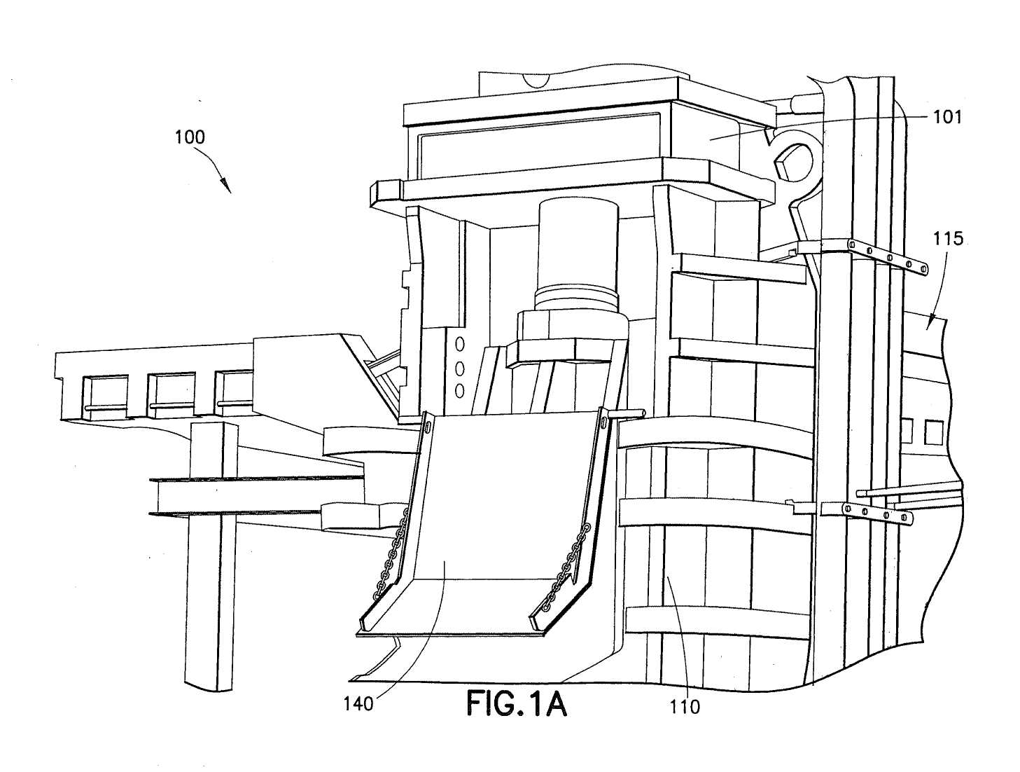

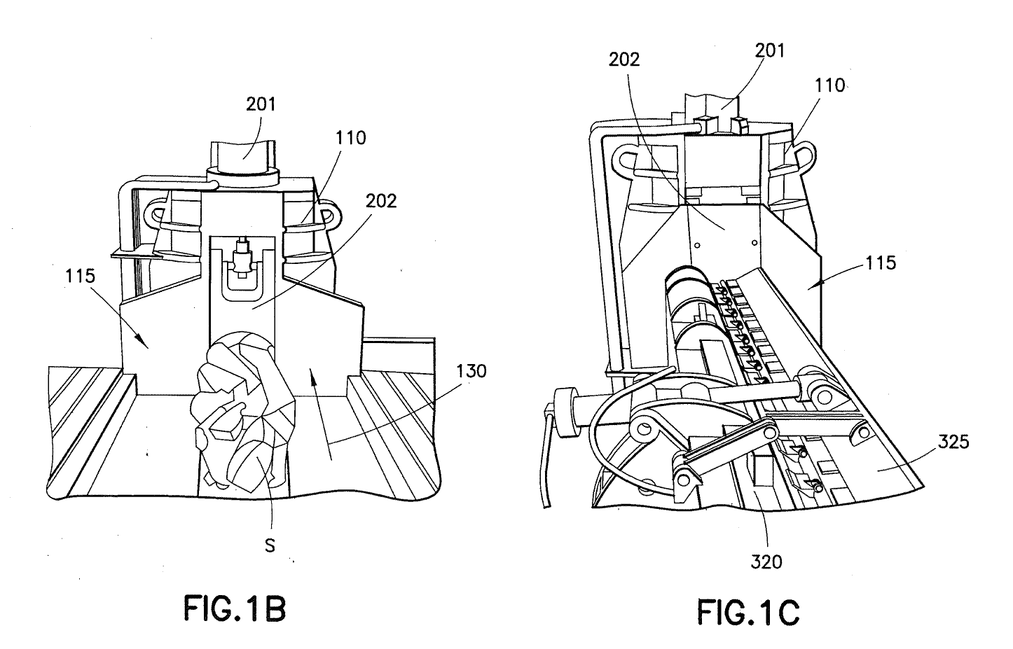

FIGS. 1A-1C illustrate an exemplary recycling machine 100 in accordance with an exemplary embodiment. Although the embodiments disclosed will be described with reference to the embodiments shown in the drawings, it should be understood that the embodiments disclosed can be embodied in many alternate forms. In addition, any suitable size, shape or type of elements or materials could be used.

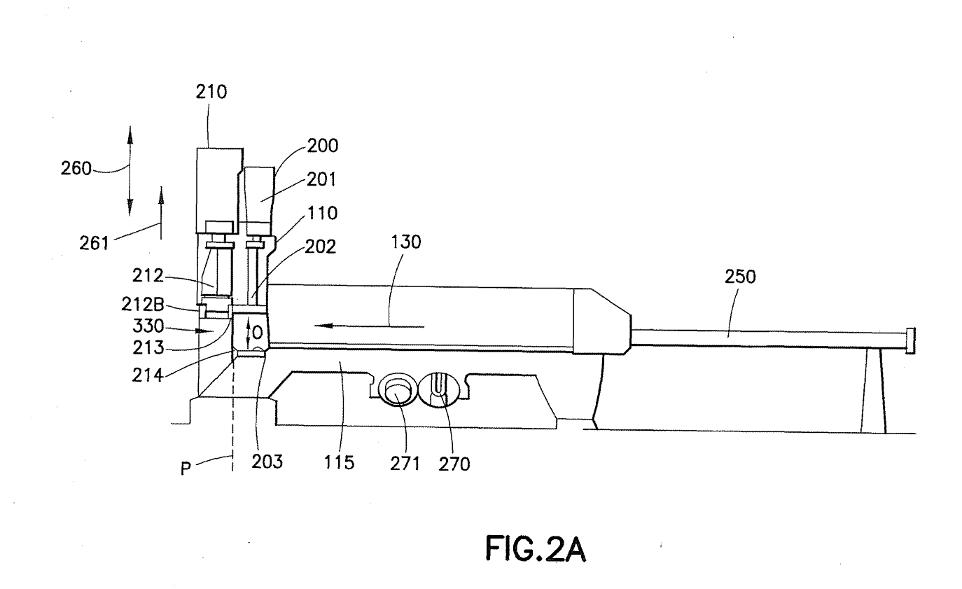

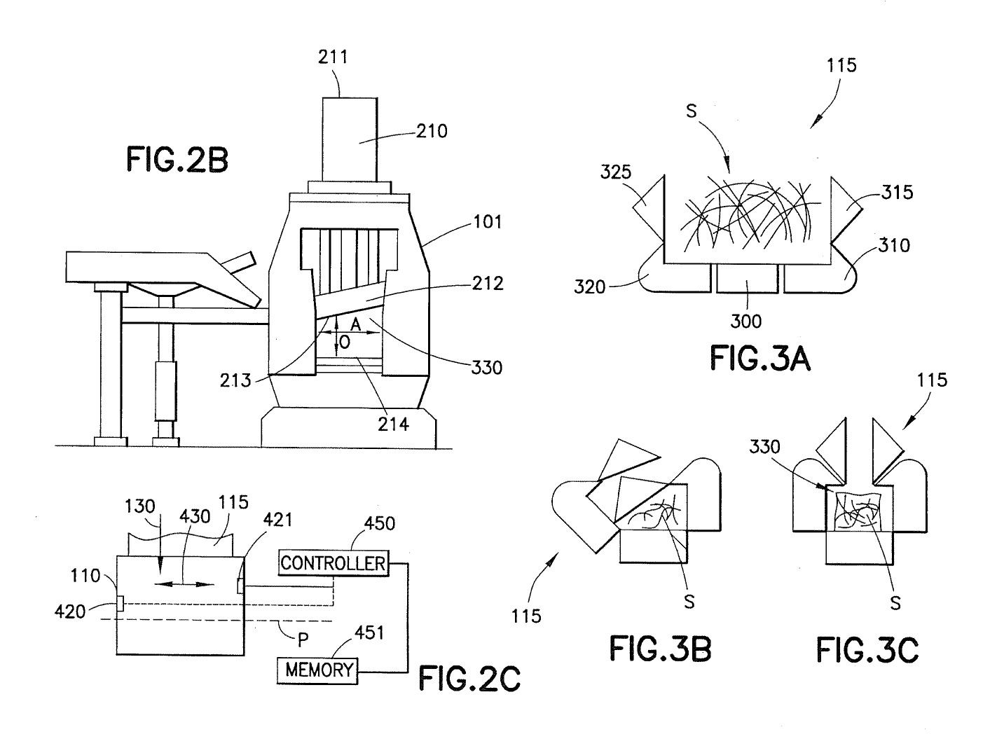

For exemplary purposes only, the recycling machine 100 is a shearing machine. In alternate embodiments the recycling machine may include a bailer for forming bails of scrap material. In still other alternate embodiments the exemplary embodiments may be applied to any suitable machine including a shear substantially similar to that described herein. In this example, the recycling machine 100 includes a frame 101 having a shear box 110 and a charging box 115. In one exemplary embodiment, the shear box 110 and charging box 115 may be separable from one another. In alternate embodiments the shear box 110 and charging box may have a unitary construction. In operation scrap material S is placed within the charging box 115 and is pushed into the shear box 110 by a ram 250 (FIG. 2A) in the direction of arrow 130 where the scrap material is sheared or cut into smaller pieces and discharged from discharge chute 140.

Referring also to FIGS. 2A and 2B, for exemplary purposes only, the shear box 110 may include a passageway that forms a channel 330 through which the scrap material is pushed. A shear 210 and a stamper or clamp 200 are disposed at least partly within the shear box 110. In alternate embodiments the shear box 110 may include only the shear 210. In this example, the clamp 200 is disposed upstream from the shear 210. The clamp 200 may include a clamp head 202 that is movably mounted within the shear box 110 for movement in the direction of arrow 260 so that the clamp head moves into and out of the channel 330. The direction of movement of the stamper head 202 is substantially perpendicular to the flow of scrap material S (as indicated by arrow 130) through the channel 330. The shear box 110 may include any suitable supports and/or guides for allowing movement of the clamp head 202 within the shear box 110. Movement of the clamp head 202 may be effected in any suitable manner, such as by, for example, any suitable drive system 201. For exemplary purposes the clamp drive system 201 may be a hydraulic drive, pneumatic drive, electric drive, or any suitable combination thereof. The clamp head 202 may cooperate with a stationary clamp plate 203 disposed within the shear box 110 beneath the clamp head 202 so that as the clamp head 202 is lowered scrap material S disposed between the clamp head 202 and clamp plate 203 is held in place for shearing. The stationary clamp plate 203 may form a portion of the channel 330 bottom.

The shear 210 includes a cross head 212 that is movably disposed within the shear box 110. The cross head 212 reciprocates substantially in the direction of arrow 260 along a cutting or shear plane P for shearing the scrap material S into smaller pieces. As described above with respect to the clamp head 202, the shear box 110 may include suitable supports and/or guides for allowing movement of the cross head 212 in the direction of arrow 260 substantially perpendicular to the direction of scrap material S flow through the channel 330. The shear 210 may include any suitable drive system 211 for causing movement of the cross head 212. In one exemplary embodiment, the shear drive system 211 may be substantially similar to the clamp drive system 201. For exemplary purposes only, the drive system 211 may be a hydraulic drive, pneumatic drive, electric drive, or any suitable combination thereof. The shear 210 also includes a pair of knife blades 213, 214. A movable knife blade 213 is disposed on the cross head 212 so as to be movable as a unit with the cross head 212. A stationary knife blade 214 is disposed, for example, on the frame 101 adjacent the clamp plate 203. The knife blades 213, 214 cooperate with each other, as the cross head 212 is lowered to shear the scrap material S held by the clamp 200 that extends underneath the cross head 212: As the scrap material S is sheared it exits the recycling machine 100 through the discharge chute 140. In one example, the sheared scrap material may pass through the discharge chute 140 by gravity while in alternate embodiments the sheared scrap material may be pushed out of the discharge chute 140 in any suitable manner, such as by movement of the scrap material S through the channel 330.

As described above, material flows from the charging box 115 through the shear box 110 and out of the discharge chute 140. For exemplary purposes only, the charging box 115 may include a ram 250 that pushes the scrap material S through channel 330 so that scrap material S is located beneath the clamp 200 and extends underneath the shear 210. In one example the ram 250 may be a hydraulic ram, electric ram, pneumatic ram or any combination thereof. In alternate embodiments the ram 250 may be any suitably powered ram for pushing the scrap material through the channel 330. Referring also to FIGS. 3A-3C, the charging box 115 may have a box bed 300, sides 310, 320 and arms 315, 325. The sides 310, 320 may be pivotally coupled to the box bed 300 and the arms 315, 325 may be pivotally coupled to a respective one of the sides 310, 320. Suitable drives 270, 271 may be connected to the sides 310, 320 and arms 315, 325 so that the sides 310, 320 and arms 315, 325 can be pivoted relative to each other and the box bed 300 for compacting scrap material S placed within the charging box 115 into a shape suitable for passage into the shear box 110 channel 330. During operation of the recycling machine 100, the sides 310, 320 may be pivoted relative to the box bed 300 so as to form an extension of channel 330 in which the ram 250 moves for pushing the compressed scrap material S in the direction of arrow 130 into the channel 330 within the shear box 110.

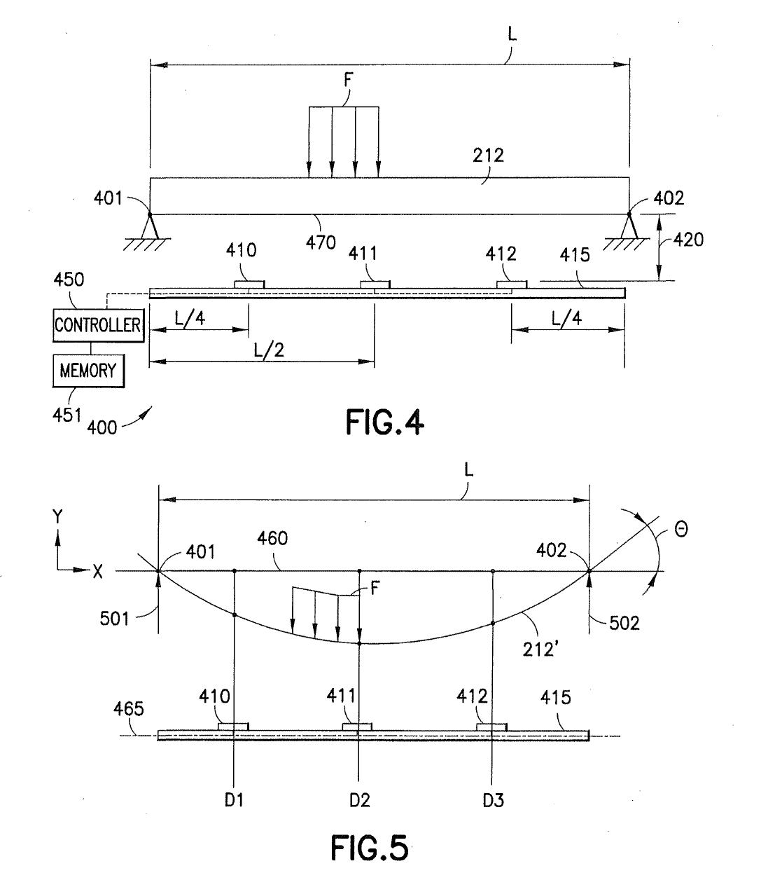

Referring now to FIGS. 4 and 5 detection of the shear deflection angle θ (e.g. a change in slope of a portion of the cross head due to deformation of the cross head from shearing forces) allows for the halting of the shearing process prior to jamming of the cross head 212 relative to, for example, the fixed knife blade 214 (or any other suitable component of the shear box 110). Jamming of the cross head 212 may occur when, for exemplary purposes only, the forces acting on the cross head 212 in a direction substantially perpendicular to the shear plane P create bearing friction, combined with friction between the cross head 212 and scrap material S, that is greater than a reaction force generated by the shear drive system 211 to pull away from the shearing of the scrap material S.

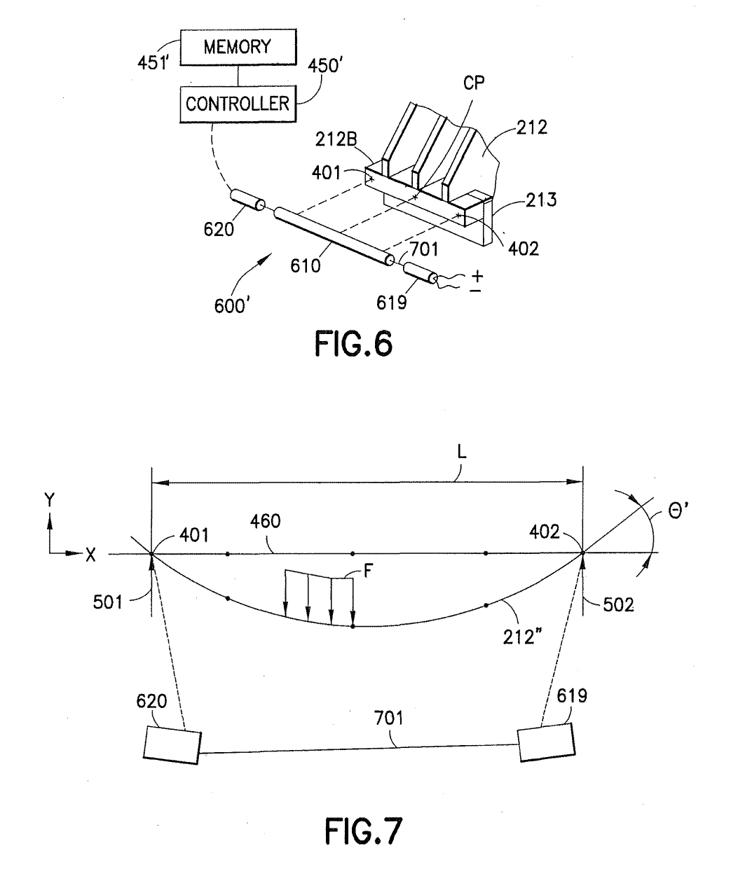

A shear deflection angle detection system 400 may be disposed at least partly within the shear box 110 for measuring deflection of any suitable portion of the cross head 212 perpendicular to the shear plane for determining, for example, the shear deflection angle θ. In one example, the shear deflection angle detection system 400 may measure a deflection of the cross head bolster 212B (e.g. a component of the cross head 212 that spans across the cross head in a direction substantially perpendicular to the shear plane P, see FIGS. 2A and 6). The bolster 212B is configured to stiffen the cross head 212 and counteract the shearing force F imparted on the shearing head 212 during shearing of the scrap material S. In alternate embodiments, the shear deflection angle detection system 400 may be positioned to measure the deflection of the movable knife blade 213. The measurement obtained by the shear deflection angle detection system 400 is made relative to two locations or ground points 401, 402 of the cross head 212 that are minimally impacted or substantially unaffected by an increase in force imparted on the cross head 212 during shearing of the scrap material S. These ground points 401, 402 of the cross head 212 form a line 460 that represents, for example, an un-deflected or relaxed condition of the cross head 212 (e.g. the cross head with no shearing forces imparted on the cross head).

The shear deflection angle detection system 400 includes a substantially rigid fixture or support 415 mounted to the ground points 401, 402 so that the support 415 travels with the cross head 212 during shearing of the scrap material S. The support has a length substantially equal to the distance L between the ground points 401, 402. The support 415 is mounted to the cross head 212 in any suitable manner so that a longitudinal axis 465 of the support 415 is substantially parallel with, for example, a line of travel or shear plane P (in direction 260) of the cross head 212. One or more sensors 410-412 may be mounted to the support 415 in any suitable manner. The one or more sensors 410-412 may be any suitable sensors for measuring relative deflection without being affected by the working environment within, for example, the shear box 110. In one exemplary embodiment the one or more sensors 410-412 may be non-contact sensors such as, for example, suitable inductive displacement sensors. These inductive displacement sensors may be configured to use, for example, a projected magnetic field for measuring a change in inductance which may be suitably translated into an analog (or digital) measurement of the change in distance of a surface 470 of the cross head 212 relative to the sensor position. In other exemplary embodiments, the one or more sensors may be, for example, linear variable differential transformers. The shear deflection angle detection system 400 may include any suitable controller 450 configured to translate data signals from the one or more sensors 410-412 into the distance measurements using any suitable algorithms and/or tables. In alternate embodiments the controller 450 may be configured to convert data signals from the one or more sensors into the distance measurements in any suitable manner.

In this example, there are three sensors 410-412 mounted to the support 415. In alternate embodiments there may be any suitable number of sensors mounted to the support 415. Here the sensors 410-412 are equidistant from each other, but in alternate embodiments the sensors may have any suitable spacing relative to each other. In this example, sensor 411 is disposed substantially in the center of the support 415 (i.e. at a distance of about L/2 from an end of the support 415). The other two sensors 410, 412 are disposed at a distance of, for example, about L/4 from their respective ends of the support 415.

During operation of the recycling machine 100, as the cross head 212 is lowered several forces are exerted on the cross head 212 as shearing of the scrap material occurs. For example, a first force (not shown) resistant to the motion of the cross head 212 acts in a direction substantially parallel with the shear plane P and is imparted on the cross head 212 along the direction 261 (FIG. 2A). A second force F is also imparted on the cross head 212 substantially in the direction of arrow 130 (FIG. 2A) perpendicular to the shear plane P. These two vector forces when combined form a resultant vector force that can be in a direction other than parallel or perpendicular to the shear plane P. As the movable knife blade 213 and/or the fixed knife blade 214 become dull and/or the spacing between the knife blades 213, 214 in a direction perpendicular to the shear plane P increases, the forces imparted on the cross head 212 increase. For example, as the second force perpendicular to the shear plane P increases in proportion to the first force parallel to the shear plane P, the shear deflection angle θ increases. The resultant vector force is resisted by reaction forces 501, 502 located at, for example, the ground points 401, 402. These resistive forces 501, 502 may be generated by suitable supports and/or guides that allow movement of the cross head 212 within the shear box 110. As only the ends of the cross head 212 are supported the first and/or second forces cause a center portion of the cross head 212 to bend or deflect as shown by the cross head 212′ in FIG. 5. Because the ground points 401, 402, to which the support 415 are mounted, are substantially unaffected by the shearing forces the support 415 remains substantially straight (or parallel) relative to the line 460 formed between the ground points 401, 402 while the center portion of the cross head 212 deflects away from the line 460. The sensors 410-412 detect a respective change in, for example, inductance as the cross head 212 moves towards and away from the sensors 410-412 and send a respective signal to the controller 450.

As described above, the controller 450 is configured to convert these sensor signals to distances D1-D3 (e.g. the deflection of the cross head 212 relative to the line 460). These distances D1-D3 are used by the controller 460 to determine the shear deflection angle θ in any suitable manner (e.g. algorithm, table, etc.). In one example, the controller 460 may compare the shear deflection angle θ with a predetermined shear deflection angle stored in, for example, a memory 451 of the controller 460 for determining whether the shear deflection angle θ exceeds the predetermined shear deflection angle. If the shear deflection angle θ exceeds the predetermined shear deflection angle the controller 460 sends a command to, for example, the shear drive system 211 for halting movement of the cross head 212 to substantially prevent jamming of the cross head 212. In one example, the controller may also be configured to reverse the direction of movement of the cross head 212 upon a determination that the shear deflection angle θ exceeds the predetermined shear deflection angle so that the cross head returns to a retracted position within the shear box 110. In alternate embodiments the distances D1-D3 between the cross head 212 and respective ones of the sensors 410-412 may be compared to predetermined distances for predicting or determining that jamming of the cross head 212 may occur.

Referring now to FIGS. 6 and 7 another exemplary embodiment of a shear deflection angle detection system 600 for the recycling machine 100 is shown. In this example, the shear deflection angle detection system 600 includes any suitable optical emitter 619 and an optical receiver 620. In one example, the optical emitter 619 may be a laser emitter or any other suitable emitter capable of emitting a substantially focused light beam 701. The optical receiver 620 may be any suitable receiver capable of detecting the light beam 701 emitted from the optical emitter 619. It should be understood that while the optical emitter and receiver 619, 620 are described herein as being separate units, in alternate embodiments the optical emitter and optical receiver may be integrated into a single transceiver unit such that a mirror (or other suitably reflective surface) is mounted on the cross head 212 opposite the transceiver unit for reflecting a light beam emitted from the emitter portion of the transceiver back to the receiving portion of the transceiver.

The optical emitter and receiver 619, 620 are suitably mounted to any suitable portion of the cross head 212. In one exemplary embodiment, the optical emitter and receiver 619, 620 may be suitably mounted to the bolster 212B. In alternate embodiments, the optical emitter and receiver 219, 220 may be suitably mounted to the movable knife blade 213. It should be understood that while the exemplary embodiments are described with respect to the optical emitter and receiver 619, 620 being mounted to the bolster 212B, the exemplary embodiments similarly apply where the optical emitter and receiver 619, 620 are mounted to other portions of the cross head 212 as described above. The optical emitter and optical receiver 219, 220 are suitably spaced apart from one another on the cross head 212 for detecting a deflection of the cross head 212 during shearing of the scrap material S as will be described below. For exemplary purposes only, in this example, the optical emitter and receiver 219, 220 are disposed on opposite ends of the bolster 212B, such as at the ground points 401, 402 but in alternate embodiments the optical emitter and receiver 219, 220 may be placed closer together. For example, one of the optical emitter and receiver 619, 620 may be mounted to the cross head 212 adjacent an end of the bolster 212B away from a respective ground point 401, 402 or at a ground point 401, 402 while the other one of the optical sensor and emitter 619, 620 is mounted to substantially a center point CP of the bolster 212B. In another example, both the optical emitter and receiver 619, 620 may be disposed adjacent the center of the bolster 212B. A protective tube 610 may be disposed between the optical emitter and receiver 619, 620 (or in alternate embodiments between the transceiver unit and mirror) to provide a substantially unobstructed pathway for the light beam 701 to pass between the optical emitter and receiver 619, 620. In alternate embodiments the optical transmitter and receiver 619, 620 may be at least partly inserted into (e.g. at least partly mounted within) the tube 610. In other alternate embodiments, the transceiver and mirror arrangement described above may be mounted to the cross head 212 in a manner similar to that described above for the optical emitter and receiver 619, 620.

A controller 450′ is connected to the optical emitter and receiver 619, 620. The controller 450′ may be substantially similar to controller 450 described above. The controller 450′ may be configured to determine a change in slope (e.g. shear deflection angle θ) of the cross head 212 based on signals from the optical receiver. For example, when the cross head 212 is in a relaxed state, as indicated by line 460 (e.g. is not shearing scrap material S) the light beam 701 from the optical emitter 619 impacts the optical receiver 620 in a predetermined location and/or at a predetermined intensity. It is noted that the deflection of the cross head 212″ may be considered as a simply supported beam of variable cross sectional strength throughout the span (between supports) across the shear plane P (FIG. 2A) such that the end points of the cross head 212″ experience a change in slope due to the deformation or deflection of the cross head 212″ subject to the shear force F as seen best in FIG. 7. As the cross head 212″ deflects during the shearing process the line of sight between the optical emitter and receiver 619, 620 changes so that the light beam 701 moves away from the predetermined location on the optical receiver 620 and/or changes intensity. The optical receiver 620 is configured to send data signals to the controller 450′ that correspond to the change in position and/or intensity of the received light beam 701. The controller 450′ may be configured with any suitable algorithms and/or tables, stored in memory 451′, for determining the change in slope of the cross head 212 based on the data signals from the optical receiver 620. The controller 450′ may determine or predict a jamming of the cross head based on the change in slope of the cross head. For example, if the change in slope of the cross head exceeds a predetermined slope stored in, for example, memory 451′ the controller may halt motion of the cross head 212 to substantially prevent jamming of the cross head. In other examples, the controller may reverse the motion of the cross head 212 upon determination that the detected change in slope of the cross head exceeds the predetermined slope so that the cross head 212 returns to a retracted position within shear box 110.

Referring to FIG. 2C a schematic top view of the shear box 110 is shown. In this exemplary embodiment, one or more sensors 420, 421 are placed on one or more walls of the shear box 110. The sensors 420, 421 may be any suitable sensors (e.g. optical sensors, capacitive sensors, strain sensors, etc.) connected to, for example, controller 450. It should be understood that while the sensors 420, 421 are described as being connected to controller 450 that the sensors may be connected to controller 450′ in a similar manner so that the sensors may be used with any of the exemplary embodiments described herein. As may be realized, as the shear 210 operates to shear the scrap material S, forces may be imparted on the scrap material S by the shear 210 which are in turn imparted on the walls of the shear box 110. For example, the material S being sheared may exert a force on the walls of the shear box in, for example, the direction of arrow 430. The magnitude of this force outward force against the walls of the shear box 110 may increase, for example, as the knife blades 213, 214 become worn. One or more sensors, such as sensors 420, 421, may be placed on or adjacent the walls of the shear box to detect a deflection of the walls as the material. S is being sheared. In one example, the sensors may be mounted to an interior or exterior portion of the shear box walls for detecting deflection of the walls. In another example, the sensors may be stationarily mounted a predetermined distance away from the walls for detecting a displacement of the walls relative to a respective one of the sensors. The controller, such as controller 450, or 450′, may be in communication with the one or more sensors 420, 421 and be configured to record the deflection or displacement of the shear box walls in a memory, such as memory 451. In this exemplary embodiment, the controller 450, 450′ may be configured to predict the jamming of the shear 210 using one or more of the deflection/displacement of the shear box walls detected by sensors 420, 421 and the change in slope of the cross head 212 (e.g. shear deflection angle θ) (as described above with respect to FIGS. 5-7).

The exemplary embodiments provide for the prediction of the jamming of the cross head 212 of the shear 210 of a recycling machine. The prediction of the jamming of the cross head 212 allows for maintenance of the cross head 212 and/or knife blades 213, 214 while forgoing damage to the recycling machine 100 and down time resulting from the cross head 212 getting jammed during shearing of the scrap material S.

It should be understood that the exemplary embodiments described herein may be used individually or in any combination thereof. It should also be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A recycling machine deflection detection system comprising:
a cross head movable within a shear box of a recycling machine;
one or more sensor units disposed on the cross head; and
a controller connected to the one or more sensor units, the controller being configured to receive deflection signals from the one or more sensor units and determine, from the deflection signals, a shear deflection angle of the cross head due to deformation of the cross head.

2. The recycling machine deflection detection system of claim 1, wherein the one or more sensor units comprise inductive sensors.

3. The recycling machine deflection detection system of claim 1, further comprising a support bar mounted to ground points of the cross head, the support bar being disposed a predetermined distance away from a surface of the cross head, wherein the one or more sensor units are disposed on the support bar and configured to effect a distance measurement between respective ones of the one or more sensors and the surface.

4. The recycling machine deflection detection system of claim 3, wherein the support bar is a substantially rigid bar substantially unaffected by the deformation of the Cross head.

5. The recycling machine deflection detection system of claim 1, wherein the cross head comprises ground points and the one or more sensors are spaced equidistantly from one another over a distance between the ground points.

6. The recycling machine deflection detection system of claim 1, wherein the one or more sensor units comprise an optical emitter and optical receiver.

7. The recycling machine deflection detection system of claim 6, wherein the optical emitter and optical receiver are spaced apart from one another such that a line of sight between the optical emitter and optical receiver changes as the cross head deforms.

8. The recycling machine deflection detection system of claim 1, wherein the controller is configured to halt movement of the cross head when the shear deflection angle exceeds a predetermined angle.

9. A recycling machine jam detection system for a shear, the jam detection system comprising:
a support fixture mounted to a cross head of the shear, the support fixture including a bar spaced apart from a surface of the cross head;
one or more sensor units mounted to the bar, each of the one or more sensor units being configured to effect detection of a change in position of the surface relative to a respective one of the one or more sensor units; and
a controller connected to the one or more sensor units, the controller being configured to determine the change in position of the surface based on data received from the one or sensors and halt movement of the cross head if the change in position exceeds a predetermined change in position.

10. The jam detection system of claim 9, wherein the surface is a bolster of the cross head.

11. The jam detection system of claim 9, wherein the surface is a knife blade of the cross head.

12. The jam detection system of claim 9, wherein the cross head includes ground points and the support fixture is mounted to the cross head at the ground points such that the bar is substantially unaffected by deformation of the cross head.

13. The jam detection system of claim 9, wherein the change in position of the surface is a slope of the surface and the predetermined change in position is a predetermined slope of the surface.

14. The jam detection system of claim 9, wherein the controller is configured to reverse a direction of movement of the cross head upon a determination that the change in position exceeds the predetermined change in position.

15. The jam detection system of claim 9, wherein the cross head is movable within a shear box of the recycling machine, the jam detection system further comprising one or more sensors disposed on or adjacent to one or more walls of the shear box, the one or more sensors being configured to detect a deflection of a respective one of the one or more walls, wherein the controller is configured to halt movement of the cross head based on one or more of the deflection of the one or more walls of the shear box and the change in position of the surface of the cross head.

16. A method of predicting a jammed shear in a machine, the shear having a movable cross head for shearing material processed through the machine, the method comprising:
providing one or more sensor units on the cross head; and
receiving deflection signals from the one or more sensor units in a controller and determining, from the deflection signals, a shear deflection angle of the cross head due to deformation of the cross head.

17. The method of claim 16, further comprising halting movement of the cross head when the shear deflection angle exceeds a predetermined angle.

18. The method of claim 16, further comprising reversing a direction of movement of the cross head when the shear deflection angle exceeds a predetermined angle.

19. The method of claim 16, wherein the one or more sensor units comprise inductive sensors.

20. The method of claim 16, wherein the one or more sensor units are spaced apart from a surface of the cross head and the deflection signals indicate changes in position of the surface relative to respective ones of the one or more sensor units.

21. The method of claim 16, wherein the one or more sensor units comprise an optical emitter and optical receiver spaced apart from one another such that a line of sight between the optical emitter and optical receiver changes as the cross head deforms.

22. A recycling machine deflection detection system comprising:
a cross head movable within a shear box of a recycling machine;
a substantially rigid member mounted to the cross head, the substantially rigid member being disposed a predetermined distance away from a surface of the cross head;
one or more sensor units disposed on the substantially rigid member, the one or more sensor units being configured to detect displacement between the cross head and the substantially rigid member; and
a controller connected to the one or more sensor units, the controller being configured to determine, from the detected displacement, a shear deflection angle of the cross head due to deformation of the cross head.
